(19) United States
(12) Patent Application Publication
(10) Pub. No.: US 2015/0024353 A1
(43) Pub. Date: Jan. 22, 2015

(54) Method and System of Simulating Critical Incidences and Media for Preparedness Exercises

(71) Applicant: SimulationDeck, LLC, Denver, CO (US)

(72) Inventors: James Paul Chesnutt, Lakewood, CO (US); Mark Ryan Amann, Centennial, CO (US); Gary David Gleason, Aspen, CO (US)

(73) Assignee: SimulationDeck, LLC, Denver, CO (US)

(21) Appl. No.: 13/946,360

(22) Filed: Jul. 19, 2013

(51) Int. Cl. G09B 19/00

(52) U.S. Cl. CPC G09B 19/00
USPC 434/219

(57) ABSTRACT

A method and system of simulating real world incidents and emergencies and the corresponding traditional media and social media responses in an access-controlled media platform for emergency training and exercises.

The current method and system relates to preparedness training and exercises and, more particularly, to a method and system of simulating real world incidents and emergencies and the corresponding traditional media and social media responses to those incidents on a secure platform.

### BACKGROUND

During military operations, natural disasters, terrorist attacks and other emergencies the needs of the media, concerned citizens and elected officials place an enormous strain on the response organizations. It is necessary for personnel handling such situations to be properly trained so that they can respond quickly and accurately to the situation. Training and exercises for emergency responders, in order to be realistic and relevant, must take into account the ability to analyze a large volume of incident-related information and data, make appropriate decisions, take appropriate actions and respond to media and social media demands. In the past, it has been impossible to replicate the pressure and demands placed on command personnel by the public, the traditional media, social media and actions taken by other organizations and agencies.

### SUMMARY

The current method and system provides a method of generating information and managing content on a secure computer based platform during a simulated critical incident. The method involves the steps of creating a simulated incident on the secure computer based platform, generating content based upon the simulated incident, alerting players to details of the simulated incident on the platform through introduction of the content, injecting response activities of simulated media within the platform, and recording of observations of player activities by controllers, evaluators and observers on an activity log. The method and system also incorporate the actions taken by the players in response to the mock incident creating a complete and realistic feedback loop for emergency training and exercises. The current method and system is a secure, password-protected platform for applications featuring realistic live and pre-produced emergency scenario information, TV and radio news story injects, newspaper and wire injects, and blogs. The program also features social media platforms that simulate current social and public media sites. These modules also house simulated military, federal, state, or local government websites that are used by exercise participants to communicate with the simulated public and the simulated media.

### DEFINITIONS

“Agency News” refers to the ability of exercise participants to post simulated information such as news releases, photos, graphics, videos for the simulated public and media on a website within the system that replicates a real world agency web site. Items posted on this site may also be linked to posts on other applications within the system such as SimulationBook and SimulationBleater.

“BleatDeck” aggregates content from SimulationBleater and SimulationBook replicating the core functionality of third-party social media management tools. It also presents a common dashboard from which users with social accounts can post directly to Bleater and SimulationBook. BleatDeck automatically and continuously updates to display the most recent social posts. BleatDeck also includes functionality to allow for hash tag searches and tagging of people.

“Content” refers to simulated activities or exercises based on a simulated critical incident.

“Controllers” plan and manage exercise play, set up and operate the exercise incident site, and may take the roles of individuals and agencies not actually participating in the exercise (i.e., in the Simulation Cell [SimCell]). Controllers direct the pace of exercise play and routinely include members from the exercise planning team, provide key data to players, and may prompt or initiate certain player actions and injects to the players as described in the Master Scenario Event List (MSEL) to ensure exercise continuity. The individual controllers issue exercise materials to players as required, monitor the exercise timeline, and monitor the safety of all exercise participants. Controllers are the only participants that provide information or direction to players.

“ControllerNotes” refers to a built in feature for controlling evaluators and observers that allows them to capture time stamped observations of how well exercise participants are performing in relation to the stated exercise objectives and expected actions agencies should take as described in national policy guidance and their own emergency plans. The system is automated to capture this information in real time and export it, automatically formatted, to meet the requirements for after action reports as directed in the Homeland Security Exercise and Evaluation Program (HSEEP).

“Evaluators” measure and assess performance, capture unresolved issues, and analyze exercise results. Evaluators passively assess and document participants' performance against established emergency plans and exercise evaluation criteria, in accordance with HSEEP standards. Evaluators have a passive role in the exercise and only note the actions/decisions of players without interfering with exercise flow.

“Exercise Times Daily” refers to a simulated web-based newspaper that can be localized to any geographic location. Multiple newspaper websites are also possible. Each story within the newspapers includes live comment streams and no layout or design of content is required. The application auto-formats all content uploaded.

“Dashboard” refers to the first screen exercise participants see when they log into SimulationDeck. Dashboard includes navigation to all of the applications within the system. It also serves as a display of the latest content that has been uploaded into each application. In this way participants can see a snapshot of what is happening in every major component of the system and easily navigate to the constituent applications to view all of the content.

“HSEEP” refers to the FEMA/DHS Homeland Security Exercise and Evaluation Program. HSEEP is a capabilities and performance-based exercise program that provides standardized policy, doctrine, and terminology for the design, development, conduct, and evaluation of homeland security exercises. HSEEP also provides tools and resources to facilitate the management of self-sustaining homeland security exercise programs. HSEEP standards serve as the basis for most emergency exercises in the United States.

“InjectDeck” is a multimedia application that introduces information to drive exercises. Initial information that describes incident event details as well as event prompts and response actions are published on this site. Players can choose to receive exercise inject notifications via email, text message, or both. These notifications are automatically generated and sent by the system.

“Online Radio” refers to a simulated web-based radio station that delivers instant radio news. Multiple radio stations are possible. Each story can be audio-marked with ‘Exercise Only’ and each story on the radio station includes live comment streams.

“Observers” review selected segments of the exercise as it unfolds, while remaining separated from player activities. Observers are often staff from participating agencies who are not playing in the exercise, but want to follow exercise events because they have implications for their job.

“SimulationBleater” refers to a secure, simulated, interactive web-based communication site providing a similar functionality to Twitter®, providing realism for training and exercises. The option of having multiple Bleater pages for participating agencies or individuals is included.

“SimulationBook” refers to a secure, simulated, interactive web-based communication site providing a similar functionality to Facebook®, providing realism for training and exercises. SimulationBook includes the core functionality of a web-based communication site within a secure environment, providing realism for training and exercises. The option of having multiple SimulationBook pages for participating agencies or individuals is included and exercise participants assigned a SimulationBook page can post text, images and video.

“SimulationCell or SimCell” refers to a virtual group where controllers generate and upload injects into InjectDeck, and provide player responses that would come from agencies, organizations and individuals not participating in the exercise, but who would be involved during a real incident. Physically, the SimCell is a working location for a number of qualified professionals who portray representatives of non-participating entities including other agencies, simulated concerned citizens, news reporters, people using social media, bloggers and others.

“SimulationDeck News (SDN)” is a web-based TV station that delivers live broadcasts, stories recorded in the field or pre-produced stories. Multiple TV stations are possible. Each story can be watermarked with ‘Exercise Only’. Each story on the TV station includes live comment streams and the option of having multiple TV stations is included.

“SimulationFrogger” refers to a secure, simulated, interactive web-based blogging application that can be adapted to the specific needs of any exercise, featuring the ability to post videos, photos, pictures and comments. It includes the ability to post videos, photos, pictures and comments and the option of having multiple blogs is included.

“SimulationTube” refers to a secure, web-based video sharing application that can be adapted to the specific needs of any exercise, featuring the ability to post videos, photos, pictures and comments.

### BRIEF DESCRIPTION OF THE DRAWINGS

FIG. 1 is a diagram illustrating one example of a method and system of project management and delivery;

FIG. 2 is an example of SimulationDeck Applications;

FIG. 3 is a screen shot of Dashboard;

FIG. 4 is a screen shot of InjectDeck application;

FIG. 5 is a screen shot of BleatDeck; and

FIG. 6 is a screen shot of an example of content creation in InjectDeck.

### DETAILED DESCRIPTION

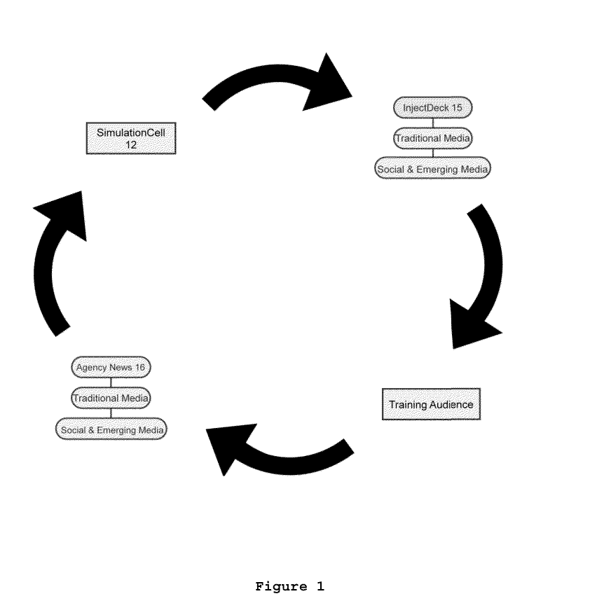

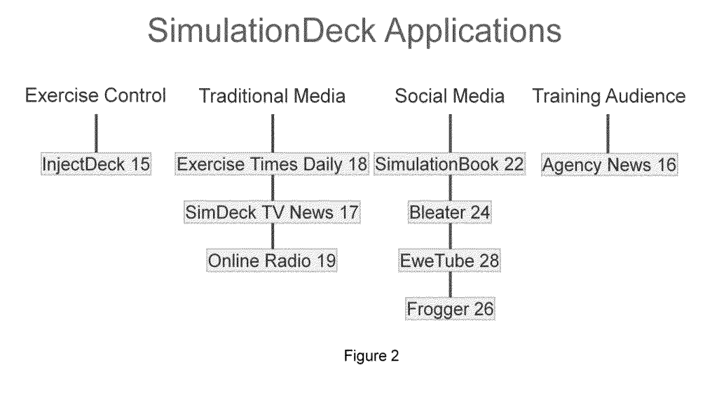

Referring in detail to FIGS. 1-6, FIG. 1 illustrates a method of generating information and managing content on a secure computer based database or platform in response to a simulated critical incident. To add realism to emergency or event preparedness exercises, a simulated incident is created and played out by exercise participants on a secure platform, referred to as SimulationDeck 12. The program is an access-controlled multimedia platform that replicates a real-time, scenario-based information environment during emergency training and exercise modules. SimulationDeck provides the ability to insert injects 15 including uploading and streaming videos, printing stories, photographs, blogs and other posts on pages that look and function like mainstream media and social media sites as shown in FIG. 2. The platform interacts and cooperates between applications serving as the primary distribution point for exercise media products and as a platform for scenario-based social media discourse.

SimulationDeck has a real time content management function 13 that operates without a delay. Injects 15 come in to the system at a realistic pace and individual exercises are kept distinct and secure from each other so there is no mixing of client content. Injects simulate real events and trigger realistic simulated responses from other media. Use of social media for crisis responders is essential. In each new crisis, social media plays an increasingly important role in responders ability to gather situational awareness and disseminate information to the public, media and partners. The platform replicates the core functionality of social media sites including a tool, Bleatdeck 29 that makes it easy to monitor social media and post to multiple sites within the platform simultaneously.

The system begins when an agency or group makes contact regarding exercises. A dedicated instance of SimulationDeck 12 is created for the client. This instance is tailored to reflect the features and applications desired for the specific client and their exercise. This customization process is fully automated by computer code that allows for the addition, subtraction and modification of the constituent applications. Training and exercise events via SimulationDeck 12 take place in a cycle. The cycle begins when the SimulationCell 14 introduces information about the incident to the training audience. The SimulationCell may use traditional media (newspaper, TV or radio) to introduce the information or it may use social media (social networks, microblogs, video/photo sharing sites or blogs) to introduce the information. Additionally, the SimulationCell or exercise control may introduce certain information via InjectDeck 15 targeted to a specific subset of the training audience, or to the entire training audience.

The training audience monitors SimulationDeck to ensure that they are receiving the necessary and relevant information. Based on this information, the organizations participating in the exercise make decisions about what operations to conduct, actions to take, resources to dedicate and what information they must disseminate to the simulated public. The training audience produces the relevant informational products and disseminates them through the appropriate applications within SimulationDeck. The training audience can choose to publish information via their own web site, represented by AgencyNews 16, and/or via their own social media sites represented by BleatDeck 29. If desired, the training audience can also interact with traditional media sites via the comments section and/or by contacting “mock media” within the SimulationCell directly. The SimulationCell creates new injects based on the information, or lack thereof, provided by the training audience. The cycle begins again and the flow of information continues.

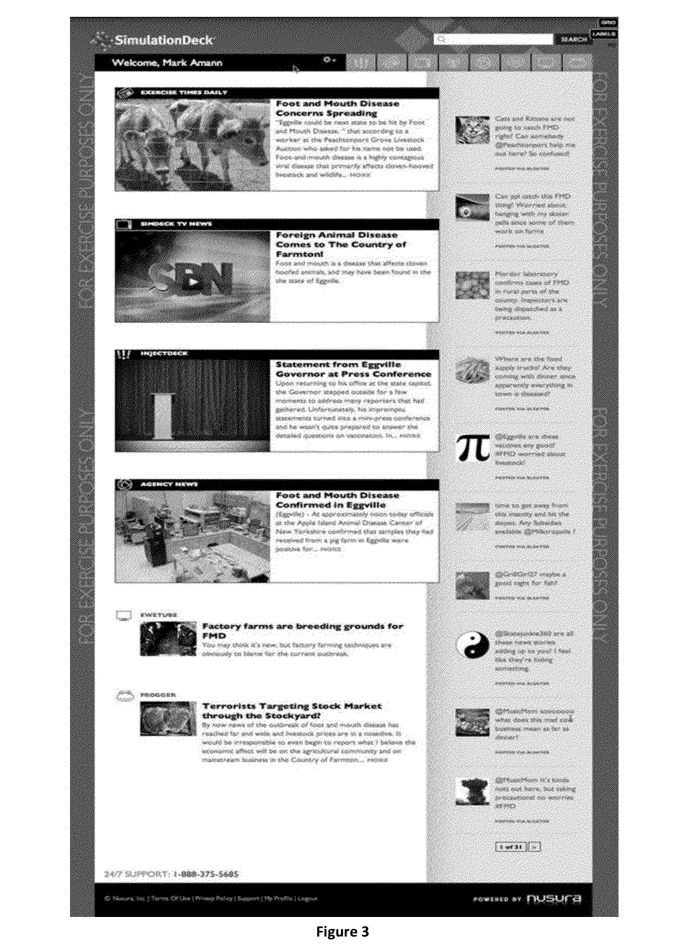

As set forth above, the program includes InjectDeck 15, a suite of interconnected, fully functioning applications that replicate Internet sites critical to emergency responders, government agencies and other exercise participants as shown in FIG. 3. The content is designed to introduce information to drive the exercise. This may include information related to traffic reports, weather, explosions, hazardous materials releases and other scenario-specific information. This content will be discussed in more detail.

Once the event exercise is created in SimulationDeck 12, there are two official sources of information for the exercise. The first is InjectDeck 15, discussed above, which displays exercise injects and other pertinent scenario-related information posted by exercise staff. The second source is Agency News 16, which displays official news from agencies and organizations participating in the exercise. The participating organizations can post press releases, fact sheets and other material that is typically released during an incident on a designated website. The platform includes groups of websites or modules that simulate every type of information available on the Internet during a critical incident, see FIG. 2. The websites are grouped into ten major categories but can be customized based on individual needs. There are TV station sites, radio, newspapers, web news, wire services, photo/video sharing sites, and several social media platforms that include the core functionality of their real world analogues.

Information is made available via the SimulationDeck Dashboard 19 which is designed to show exercise participants and representatives from the exercise staff (exercise control and the SimulationCell) what is happening in the exercise at a glance. To achieve this, the platform is programmed to display the most recent post from each application on the Dashboard 19. The SimulationDeck Dashboard, as shown in FIG. 3, displays in a column on the left-hand side of the page the most recent post from InjectDeck 15, Exercise Times Daily 18, SimulationDeck TV News 17, Online Radio 19, Agency News 16, SimulationTube 28 or Ewetube and SimulationFrogger 26 or Frogger. Included in each post's digest is the time of the post, the application where the post was made, the headline, a thumbnail photo, and a short sample from the post's text. On the right-hand side of the screen, the Dashboard's code pulls the most recent posts from SimulationDeck's major social networking applications, SimulationBook 22 and SimulationBleater 24 or Bleater. Included in each post is the posting user's name, content from the post and the posting user's thumbnail photo.

The configuration of the Dashboard 19 is customizable by the exercise controllers. Posts may be displayed in any order and may be rearranged on the fly. Additional media outlets may be added and customized with the click of a button. The Dashboard is programmed to refresh each user's view automatically at an interval that is customizable. This means that a user may see the most recent posts from all around SimulationDeck's traditional and social media sites without ever interacting with the platform or clicking any buttons.

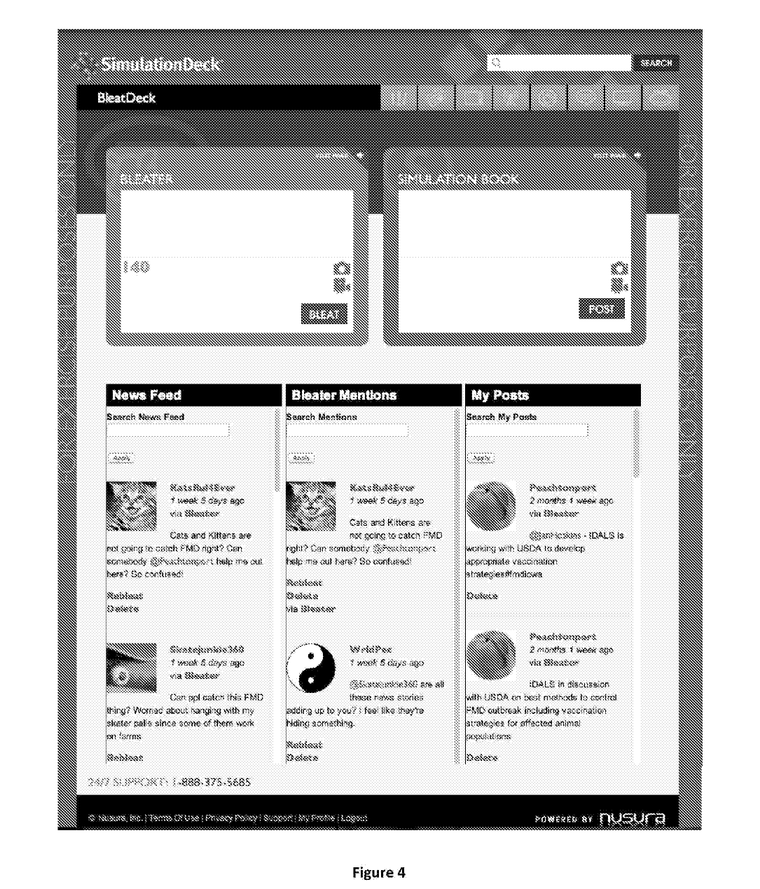

InjectDeck 15 is infinitely customizable and there are unlimited options for the auto-creation of as many or as few TV stations, newspapers and social media applications as needed. Traditional media modules are also generated that comment on the simulated incident and response efforts. These include Exercise Times Daily 18, SimulationDeck TV News 17, and Online Radio 19. The social media modules generated include, SimulationBook 22, SimulationBleater 24, SimulationFrogger 26 allowing exercise staff to simulate blogs that are meaningful to the incident using the SimulationFrogger platform and SimulationTube 28. See FIG. 4.

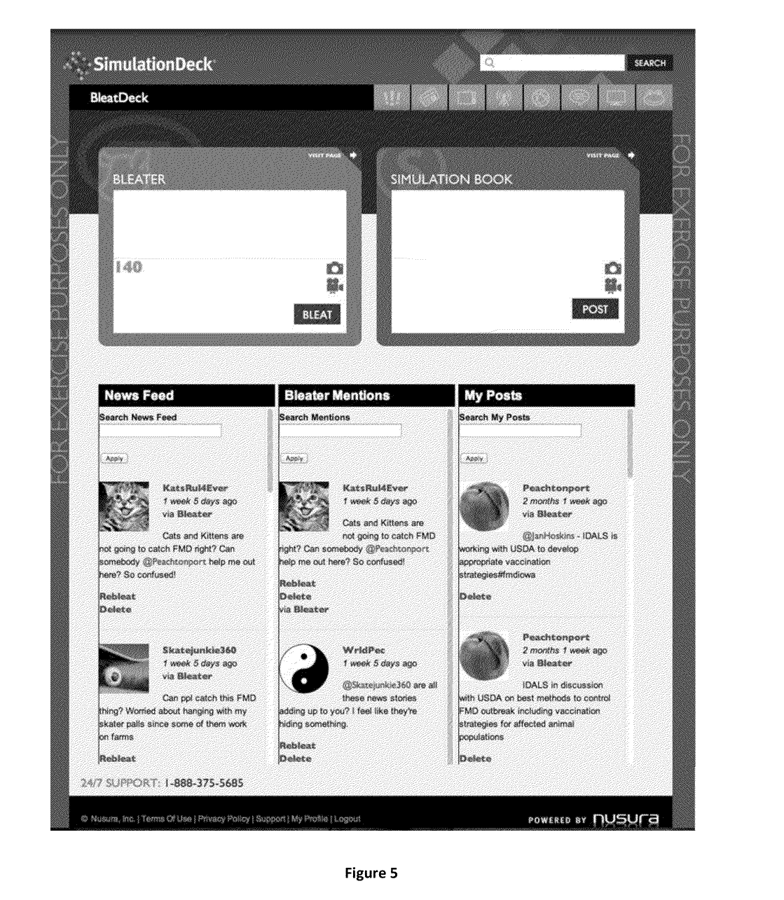

BleatDeck 29 is SimulationDeck's social media aggregation application. Its main function is to act as a common dashboard showing all posts made to SimulationDeck's social networking (SimulationBook) and microblogging (SimulationBleater) applications, and providing a single place for users to post to those applications, see FIG. 5. The posting receives a user's post and provides the opportunity to attach either an audio or video file to that post. For a SimulationBleater post, the application's code counts the characters that a user types into the entry box backwards from 140, the limit for characters in a SimulationBleater post.

When a user posts to either SimulationBleater 24 or SimulationBook 22, BleatDeck's front-end code automatically displays the information from the database in the “My Posts” column. The application also shows the SimulationBleater posts in which a user has been “mentioned” using the @ symbol before the user's name. The “News Feed” column displays all posts made to both social applications. BleatDeck personalizes its display for the user. No two users will see BleatDeck the same way, because the application displays their personalized “My Posts” and “Bleater Mentions” columns.

Users can tag other people or organizations in any post using the @ symbol. For example, typing @JohnDoe in a post will automatically send that post to John Doe's Mentions column, letting him know that someone is posting about him. BleatDeck automatically formats all URLs as hyperlinks, this is true as well of all other applications within SimulationDeck. BleatDeck and Bleater both support the use of hash tags. When a user types #keyword in a Bleater post, BleatDeck will create a hyperlink in that post that, when clicked, will display all the posts made from all around Bleater using that #keyword. Users can “ReBleat” any post made by another user to Bleater or SimulationBook simply by clicking “ReBleat”. This will publish the post under the user's “My Posts” column.

Four categories of people are involved in a standard exercise: 1) Players (or training audience), 2) Controllers who design and facilitate the exercises, and 3) Evaluators and 4) Observers. SimulationDeck 12 includes three corresponding levels of ‘permissions’ for each category. For example exercise players can add content to their AgencyWeb page, as they can in real life, but they cannot publish a newspaper story on the newspaper site. Controllers perform many tasks within SimulationDeck, including directly editing and customizing code in the database. In this way controllers create users, accounts and various types of content within SimulationDeck. The controller permissions also allow for assigning roles to users and generating reports. SimCell-level permissions allow individuals to add content to all the platforms to carry out their role as concerned citizens using social media, members of the traditional media and representatives of other agencies that would be involved during a real work even but who are being simulated for the exercise. Evaluators participate by providing input as to players performance during the exercise.

Essential to simulating realistic conditions on social media is the ability for exercise staff members to be able to simulate a large number of people. SimulationDeck's permissions and roles allow for controllers, [site managers and administrators] to quickly switch between users to simulate a conversation between users on social media or in the comments section of the traditional media applications.

One tool that can be utilized is the Switch User Tool that is only visible to the controller. As the exercise staff members begins typing in the box, the application searches the user database in real time to locate user names that match what is being typed. The user can execute the switch and will now be using the application under a chosen name. Comments and posts made by the exercise staff member will now appear within SimulationDeck as being made by chosen name. To simulate a conversation between social media users, the exercise staff member will switch to another user using the Switch User tool. This allows controllers in the SimCell to have multiple personas. In this way 10 controllers, with 25 personas each for example would appear to exercise participants in SimulationDeck as 250 people.

In some cases exercise staff members may need to produce content to be published at a later time. SimulationDeck's scheduler functionality allows the exercise staff member to create the post, attach the relevant images or photos, upload them to the database and specify a time for that post to be published. When creating content, the exercise staff member simply enters the date and time that the post should be published and saves the post to the content management system (CMS). SimulationDeck's server side code runs a chronological review of all the content within the CMS at a customizable interval, usually every few seconds. When the server finds a post in the database with a scheduled post time that has passed, the post is automatically published and will now be available for viewing by the exercise audience.

SimulationDeck has an additional feature called RePlay that is activated for clients who would like the ability to auto-publish content on the various platforms and then be able to speed up the rate of publishing, slow it down, as well as pause and reverse the content publishing. This allows clients to study and better understand how information propagates on traditional and social media. This also allows clients to upload a large volume of social media data into SimulationDeck from actual past time periods or simulated material and then have that data (Facebook and Twitter posts, for example) replayed on the social media platforms within SimulationDeck. RePlay allows for the data to be published/presented on SimulationDeck's social media platforms at any prescribed rate. This feature has applicability to military, intelligence agencies as well as major corporations who seek to understand how social media related to their endeavors spreads and changes along the way.

Organizations can choose to staff the SimulationCell themselves, or a custom package of support to include loading a Master Sequence Events List, adding users, and even providing mock media such as TV crews, newspaper reporters and the like can be provided by SimulationDeck staff. The platform can be used for any type and duration of exercise including Tabletop exercises, Games, Drills, Functional and Full Scale Exercises. It can also be used for training.

SimulationDeck's front end code interacts with a server-side database to enable creating and managing users. SimulationDeck also automates the process of assigning and creating customized web and social accounts within the platform. To create a user, a controller enters basic information about the user. This includes user name, password and email address. Next, the controller assigns a role to the user. This role will determine what parts of SimulationDeck the new user will be able to see, and what functions the new user will be able to perform.

Next, the controller assigns an account within SimulationDeck's social and web applications. A new user may be assigned its own Agency News page, Bleater account, Frogger blog, SimulationBook account, or EweTube video sharing channel. Finally, the controller can choose to assign a photo to the user profile. Once the new user account is created, SimulationDeck's server side code automatically creates the appropriate pages on the front end, and creates corresponding database entries. The controller can choose whether or not to notify the new user of the newly created account via email. SimulationDeck automatically and instantly creates web and social pages for the new user.

SimulationDeck's server side code allows for the automatic creation of users in bulk via the upload of a comma separated values (CSV) file. The controller can easily create a CSV file for import into SimulationDeck's user database. Once the file is uploaded, SimulationDeck's server side code automatically creates the users and assigns the appropriate roles, permissions and web/social pages. SimulationDeck's code limits the view of certain users to only those elements of SimulationDeck necessary for them to perform their functions. Players can see all content posted to SimulationDeck's applications, and where available, can post comments. If a player is assigned a web page or social account within SimulationDeck, then the player can create content. SimulationDeck limits the view of players to only the content and the front-facing applications. SimulationDeck's permissions code allows controllers to document player performance using a tool called ControllerNotes. SimulationDeck's permissions do not allow players to see ControllerNotes. ControllerNotes captures findings and observations from exercise staff useful for after action reporting, an essential function of emergency training and exercises. Observations and findings are captured in SimulationDeck's database, as well as the user who posted the note and the time the note was posted. These notes are organized by the exercise objective they are associated with. After the exercise SimulationDeck generates a comma separated values file that can easily be copied and pasted into an after action report.

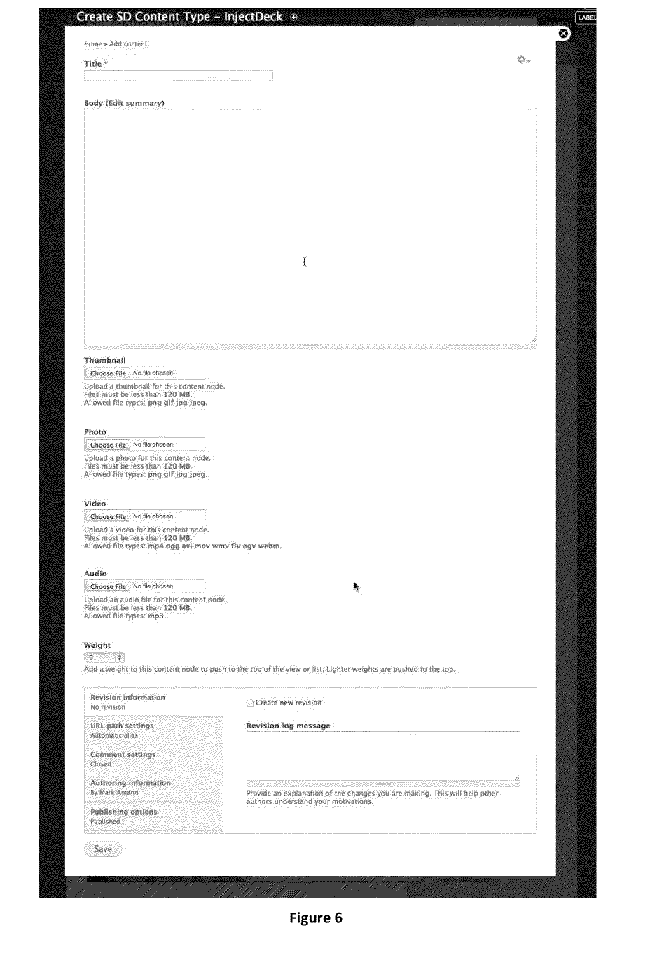

SimulationDeck has a real time content management system so there is no formatting step between content development and content publishing. This allows the injects come into the system at a realistic pace. The client can request any combination of pre-produced material based on the exercise scenario, and content produced during the exercise in real time. Exercise staff members can easily create content using SimulationDeck's content management system (CMS). See FIG. 6. Depending on where the content is to be published, the post may require a title/headline, body copy, a thumbnail image for viewing on the application's landing page, a photo or video, or an audio file. Newspaper posts are published in the newspaper application and are automatically formatted to appear as a realistic newspaper article. SimulationDeck's code automatically assigns the user's name and profile picture to comments.

SimulationDeck features streaming server capabilities to allow for live broadcasts as well as the posting of prerecorded video and audio files. The application can accept either a video or audio feed and distribute the streaming feed anywhere in the world. Master scenario events lists (MSEL) can be uploaded for easy deployment during any training event allowing injects to be deployed automatically or manually.

The platform may be cloud based, allowing controllers, evaluators, observers and players to participate from anywhere. This reduces the need for travel and reduces costs for exercise staff. The platform is also optimized for mobile devices, participants stay engaged no matter what device they are using.

InjectDeck notifies participants from all functional areas of exercise events in real time. This streamlines the facilitation of an exercise whether participants are together in one room or scattered around the globe. Participants use their everyday communication and coordination tools such as phones, email, text, chat and EOC software. The platform simulates the rest. Participants can opt to receive notifications via email, text message, or both and can monitor news coverage of the crisis to ensure that key messages are being picked up by the media and amplified by social media sites. If the media report rumors or misinformation, participants correct the issue. As the exercise unfolds, participants receive real time feedback on their decisions as reflected in simulated media sites and partner agency websites. Participants use BleatDeck for easy social media monitoring and posting to SimulationBook, and Bleater. SimulationTube and SimulationFrogger, mirror the core functionality of video sharing sites. Players can post news releases, backgrounds, fact sheets and advisories to their own AgencyWeb page.

In addition to the above, further aspects and embodiments will become apparent by reference to the drawings and by study of the preceding descriptions. Exemplary embodiments are illustrated in reference to Figures of the drawings. It is intended that the embodiments and Figures disclosed herein are to be considered illustrative rather than limiting.

We claim:

1. A method of generating information and managing content on a secure computer-based platform in response to a simulated critical incident comprising the steps of:
creating said simulated critical incident on said secure computer based platform;
generating content based upon a verbal or written description of said simulated critical incident;
alerting players to details of said simulated incident via said platform through introduction of said content to said platform;
injecting response activities of said players and of simulated media within said platform; and
recording observations of player activities by controllers, evaluators and observers on an activity log.

2. The method of generating information and managing content according to claim 1 wherein said step of injecting response activities further includes displaying pre-recorded television, radio and newspaper reports.

3. The method according to claim 1 wherein said simulated critical incident includes a password-protected platform.

4. The method according to claim 1 wherein said media response activities include injects from simulated social media applications, video applications and web-based communication sites.

5. The method according to claim 1 wherein said step of generating content is defined by a real time content management system.

6. The method according to claim 1 wherein said method further includes the step of simulating interactions with third parties.

7. The method according to claim 1 wherein said media injects may be published at pre-determined times on said platform.

8. The method according to claim 1 wherein said platform includes compiling and reporting of training notes.

9. The method according to claim 1 wherein said method further includes the step of assigning and creating customized web and social accounts.

10. The method according to claim 4 wherein said simulated social media applications are adapted to monitor and post data to multiple sites simultaneously.

11. A computer-aided method of generating training and exercise modules for a simulated event, the steps comprising:
selecting a simulated event and generating detail data regarding said event, wherein said detail data is comprised of at least one of text data, news data, video data and social media data;
receiving data input information regarding said simulated event;
selectively inserting said data input information into applications within SimulationDeck;
distributing SimulationDeck information to players via electronic means;
restricting general public access to said files; and facilitating display of further information regarding said simulated event.

12. The method according to claim 11 wherein said electronic means includes a computer, handheld electronic device or any type of web based electronic display.

13. The method according to claim 11 further including the step of recording selected information to ControllerNotes.

14. The method according to claim 11 further including the step of replaying designated social media data at a prescribed rate.

15. In a system for generating information and managing content relating to emergency preparedness exercises wherein a computer is provided for processing data, a database is provided for recording said information and a screen is provided for displaying said information recorded, the improvement comprising:
generating means including means for creating and storing simulated incident data on said database;
managing means including first means for recording and updating supporting simulated incident data on said database, second means for alerting players regarding said simulated incident data and said supporting simulated incident data, third means for injecting response activities of simulated media, and fourth means for updating data on said database; and
means for displaying said data on a dashboard on said computer.

16. In a system according to claim 15 including means for displaying social media data on a dashboard.

17. In a system according to claim 15 including means for replaying information at pre-determined times.

18. In a system according to claim 15 including means for switching users to simulate additional input and players on said database.

19. A method of simulating events for emergency preparedness exercises using a secure server, the method comprising the steps of:
designing a critical event and creating an incident support for said critical event on a secure platform having simulated media sites;
relaying said critical event details to players during a simulated exercise;
injecting critical event prompts and response actions from said simulated media sites; and
recording said player's actions and responses to each said critical event on said secure platform.

20. The method according to claim 19 wherein said step of injecting media prompts and response actions includes utilization of data selected from the group consisting of blog sites, TV stations, newspapers, web news, and interactive social media sites.

21. The method according to claim 19 wherein said method further includes the step of displaying said event details, said event prompts and said response actions on a dashboard display.

22. A system of achieving effective event preparedness exercises, said system comprising:
a secure platform having a plurality of fields of information, selected of said fields corresponding but not limited to:
an event selection application having a list of simulated events for selecting a desired event;
an injection application defined by stored incident intelligence information;
an agency application including radio, news and television having a list of defined tasks;
a social media application; and
a transaction event application.

23. The system according to claim 22 wherein retrieval of said selected of said applications enables display of categories of information selected from the group consisting of said event selection application, said injection application, said agency application, said social media application, and said transaction event application.

24. The system according to claim 23 wherein said applications include interactive participation between players.
